(19) United States
(12) Patent Application Publication
(10) Pub. No.: US 2004/0015320 A1
(43) Pub. Date: Jan. 22, 2004

(54) Bottom adjusting action control system for a bed or the like

(76) Inventors: Hiroshi Nagaoka, Tokyo (JP); Masao Horitani, Tokyo (JP); Satoru Inoue, Tokyo (JP)

Correspondence Address: TOWNSEND & BANTA, P.C., Suite 900 South Building, 601 Pennsylvania Avenue N W, Washington, DC, 20004, US

(21) Appl. No.: 10/389,961

(22) Filed: Mar. 18, 2003

(30) Foreign Application Priority Data
Mar. 18, 2002 (JP) 2002-75077

(51) Int. Cl. G06F 15/00

(52) U.S. Cl. 702/150

(57) ABSTRACT

A bottom adjusting action control system for a bed or the like, characterized in that when the bottom sections of the bed or the like are adjusted to desired positions, an adjusting action pattern till reaching the desired positions can be preset.

### FIELD OF THE INVENTION

The present invention relates to a bottom adjusting action control system for a bed or the like, which allows a bottom coordinative action pattern to be preset so that when the bottom sections of the bed or the like are adjusted to desired positions, the adjusting action can be carried out according to a desired bottom coordinative action pattern.

### BACKGROUND OF THE INVENTION

At present, the position adjusting functions for bottom sections of a bed or the like include such functions as adjusting the inclinations of bottom sections (such as the back bottom section and the knee bottom section), adjusting the heights of the bottom sections, adjusting the expansion and contraction, and rolling. These functions are actuated based on the control commands issued from remote control switches or the control switches mounted on a control panel operated by an attendant, nurse or the like, to bring the bottom sections to respectively desired positions.

Problems of the prior art However, the above-mentioned functions of a bed or the like are usually merely carried out according to an action pattern preset when the bed or the like is produced.

So, for example in the case where back lifting only is carried out, a forward sliding force acts from the mattress on the back bottom section to the upper half of the body, to press the abdominal region. To prevent the pressure feeling and forward sliding during back lifting, it is proposed to operate the back bottom section and the knee bottom section in an coordinativeed manner. However, if back lifting and knee lifting are operated in an coordinativeed manner according to a predetermined action pattern from the beginning, it is not possible to stop knee lifting only halfway or to move the bottom sections in such a manner as to deviate from the action pattern, thus diluting the effect of inhibiting the pressure feeling and forward sliding during the aforesaid back lifting.

This invention is proposed to improve the above-mentioned problem. The object of this invention is to provide a bottom adjusting action control system for a bed or the like, in which when the bottom sections of the bed or the like are adjusted to desired positions, a bottom coordinative action pattern can be preset to allow the adjusting action according to the desired bottom coordinative action pattern.

### SUMMARY OF THE INVENTION

To solve the above-mentioned problem, in this invention, claim 1 discloses a bottom adjusting action control system for a bed or the like, characterized in that when the bottom sections of the bed or the like are adjusted to desired positions, an adjusting action pattern till reaching the desired positions can be preset.

Furthermore, in this invention, claim 2 discloses a bottom adjusting action control system for a bed or the like, characterized in that when a back bottom section is lifted and lowered, a bottom coordinative action pattern for back lifting and lowering accompanying knee lifting and lowering till reaching a back lifting angle of the back bottom section can be preset.

Still furthermore, in this invention, claim 3 discloses a bottom adjusting action control system for a bed or the like, characterized in that when the lifting of the back bottom section and the lifting of the knee bottom section of the bed or the like are adjusted, a bottom coordinative action pattern till reaching desired positions can be preset.

Still furthermore, in this invention, claim 4 discloses a bottom adjusting action control system for a bed or the like, wherein the time difference between the time instant of starting the knee lifting of the knee bottom section and the time instant of starting the back lifting of the back bottom section, and a knee lifting time period of the knee bottom section, are preset in a bottom coordinative action pattern for the back lifting of the back bottom section, wherein the knee lifting of the knee bottom section is started at first; subsequently after lapse of said preset time difference, the back lifting of the back bottom section is started; and after lapse of said preset knee lifting time period of the knee bottom section, the knee lifting of the knee bottom section is stopped and then the knee lowering of the knee bottom section is started, while the back lifting of the back bottom section is continued till reaching a desired back lifting angle.

Still furthermore, in this invention, claim 5 discloses a bottom adjusting action control system for a bed or the like, wherein the time difference between the time instant of starting the knee lifting of the knee bottom section and the time instant of starting the back lifting of the back bottom section, and a knee lifting angle of the knee bottom section, are preset in a bottom coordinative action pattern for adjusting the back lifting and knee lifting of the respective bottom sections, wherein the lifting of the knee bottom section is started at first; subsequently after lapse of said preset time difference, the back lifting of the back bottom section is started; and if the knee bottom section reaches the preset knee lifting angle, the knee lifting of the knee bottom section is stopped, while the back lifting of the back bottom section is continued till reaching a predetermined back lifting angle.

In this invention, the bed or the like includes a hospital bed, stretcher, ICU bed or a long-term care bed.

According to claim 1, when the bottom sections of a bed or the like are adjusted to desired positions, they can be adjusted according to a desired adjusting action pattern. So, the bottom sections can be adjusted to suit the lying person with a less burden imposed on him/her.

According to claim 2, when the back bottom section of a bed or the like is lifted and lowered, the lifting and lowering can be carried out according to a preset bottom coordinative action pattern accompanying the lifting and lowering of the knee bottom section. Therefore, the lifting and lowering of the back bottom section can be adjusted with the forward sliding and pressure feeling reduced.

According to claim 3, when the back lifting and knee lifting of the respective bottom sections of a bed or the like are adjusted, the adjustment can be carried out according to a bottom coordinative action pattern suitable for the lying person. So, the lifting and lowering can be adjusted with a less burden imposed on the body of the lying person.

According to claim 4, since the time difference between the time instant of starting the knee lifting of the knee bottom section and the time instant of starting the back lifting of the back bottom section, and a knee lifting time period of the knee bottom section, are preset, the bottom coordinative action pattern for the back lifting of the back bottom section can be newly set.

According to claim 5, the time difference between the time instant of starting the knee lifting of the knee bottom section and the time instant of starting the back lifting of the back bottom section, and a knee lifting angle of the knee bottom section, are preset in a bottom coordinative action pattern for adjusting the back lifting and knee lifting of the respective bottom sections.

### BRIEF DESCRIPTION OF THE DRAWINGS

FIG. 1 is a side view showing an example of the bed apparatus for carrying out the bottom adjusting action control system of this invention

FIG. 2 is a block diagram for illustrating the bottom adjusting action control system in the bed apparatus shown in FIG. 3

FIG. 3 is a graph showing an example of the bottom coordinative action pattern preset in the bottom adjusting action control system shown in FIG. 1

FIG. 4 is a side view showing the entire form of a bottom in a state where all the bottom sections are kept down to lie flat.

FIG. 5 is a side view showing the entire form of a bottom in one phase in the lifting action, in the case where the method of controlling the coordinative lifting of bottom sections of this invention is applied to a bed.

FIG. 6 is a side view showing the entire form of a bottom in another phase in the lifting action, in the case where the method of controlling the coordinative lifting of bottom sections of this invention is applied to a bed.

FIG. 7 is a side view showing the entire form of a bottom in a further other phase in the lifting action, in the case where the method of controlling the coordinative lifting of bottom sections of this invention is applied to a bed.

FIG. 8 is a side view showing the entire form of a bottom in a still further other phase in the lifting action, in the case where the method of controlling the coordinative lifting of bottom sections of this invention is applied to a bed.

FIG. 9 is a side view showing the entire form of a bottom in a still further other phase in the lifting action, in the case where the method of controlling the coordinative lifting of bottom sections of this invention is applied to a bed.

### DETAILED DESCRIPTION OF THE PREFERRED EMBODIMENTS

For the bottom adjusting action control system for a bed or the like of this invention, an embodiment is described below based on the attached drawings.

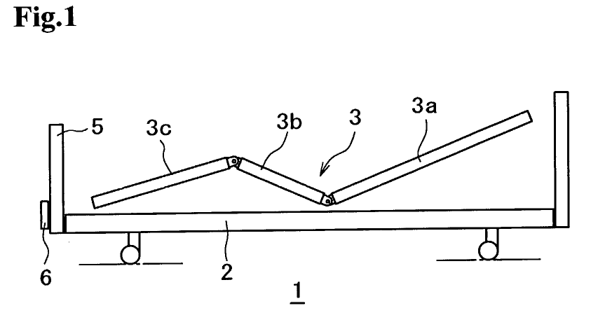

FIG. 1 shows a bed apparatus 1. In the bed apparatus 1, a bottom 3 placed on a bed frame 2 is divided into a back bottom section 3a corresponding to the back, a knee bottom section 3b corresponding to the region from the waist to the knees and a leg bottom section 3c corresponding to the legs. Though not illustrated, a back lifting link as a back lifting mechanism abuts the back side of said back bottom section 3a, while a knee lifting link as a knee lifting mechanism is attached to the back side of the knee bottom section 3b for lifting and lowering the knee bottom section 3b and the leg bottom section 3c in an coordinativeed manner. The back lifting link and the knee lifting link are respectively connected to drive means (described later), for allowing back lifting and knee lifting.

That is, the back lifting mechanism of the back bottom section 3a and the knee lifting mechanism of the knee bottom section 3b of the bed apparatus 1 are actuated by means of a bottom adjusting action control system 4, for allowing back lifting, knee lifting and the coordinative action of back lifting and lowering and knee lifting and lowering.

Said bottom adjusting action control system 4 is described below.

In the bottom adjusting action control system 4, the control switches (described later) mounted on a control panel 6 for giving control commands, installed on the outer surface of a footboard 5 are operated to give action command signals to a controller 7 mounted on a control box (not illustrated) placed on the bed frame 2, and controlled action power is supplied from the controller 7 to the motors 8a and 8b functioning as drive sources of the back lifting mechanism and the knee lifting mechanism, for starting the motors 8a and 8b. On the other hand, the controller 7 obtains the position information of the respective bottom sections from the action detecting means (not illustrated) of the motors 8a and 8b. Furthermore, the controller 7 of the bottom adjusting action control system 4 has a storing means 9 mounted for storing the coordinative action pattern of the bottom 3 described later.

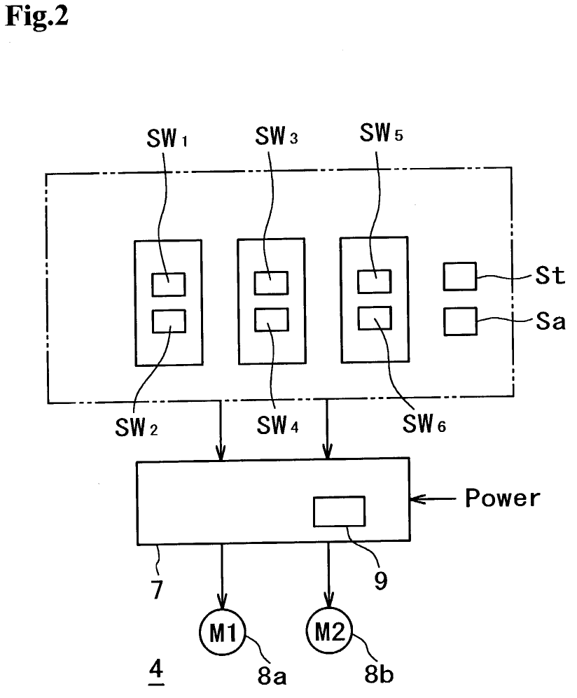

The control panel 6 installed on the outer surface of the footboard 5 is described below. As shown in FIG. 2, the control panel 6 has control switches for back lifting and lowering, knee lifting and lowering and coordinative action of back lifting and lowering and knee lifting and lowering, i.e., head lifting switch Sw1, head lowering switch Sw2, leg lifting switch Sw3, leg lowering switch Sw4, back lifting and knee lifting coordinative switch Sw5 and back lowering and knee lowering coordinative switch Sw6.

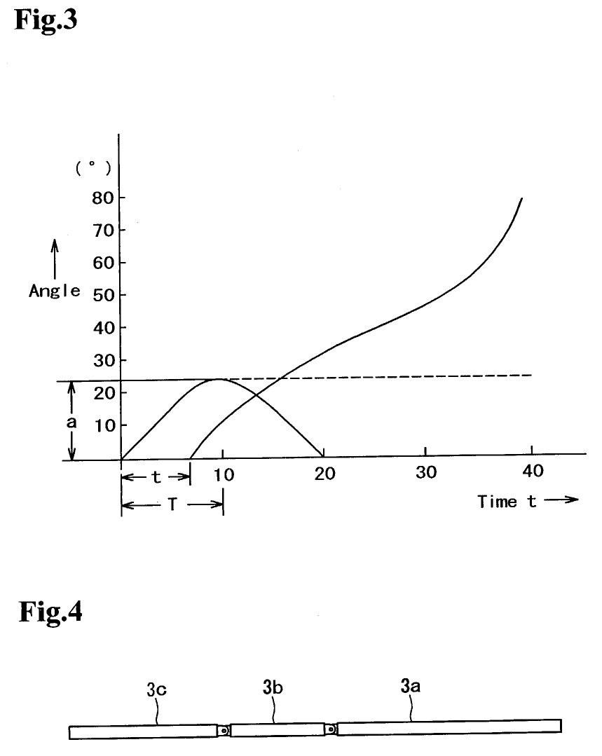

The control panel 6 also has a time difference setting switch St for presetting the time difference (t) between the time instant of starting the back lifting of the back bottom section 3a and the time instant of starting the knee lifting of the knee bottom section 3b, and an angle setting switch Sa for presetting the knee lifting angle a for presetting a bottom coordinative action pattern, for example, as shown in FIG. 3.

The time difference (t) and the knee lifting angle a respectively preset by the time difference setting switch St and the angle setting switch Sa are stored in the storing means 9 in the controller 7, and based on the data stored as a newly preset action pattern, the back bottom section 3a and the knee bottom section 3b are operated in an coordinativeed manner.

Furthermore, the controller 7 has the following control procedures preset in it.

(1) As switching for back lifting, knee lifting is started (the knee lifting motor is turned on for normal rotation), and after lapse of time t, back lifting is started (the back lifting motor is turned on for normal rotation). If the knee lifting angle a reaches the preset angle, knee lifting is stopped (the knee lifting motor is turned off), and knee lowering is started (the knee lifting motor is turned on for reverse rotation). The time difference t is set by means of the time difference setting switch St, and the knee lifting angle a is set by means of the angle setting switch Sa.

(2) For switching for gatch action (concurrent back lifting and knee lifting), knee lifting is started (the knee lifting motor is turned on for normal rotation), and after lapse of time t, back lifting is started (the back lifting motor is turned on for normal rotation). If the knee lifting angle a reaches the preset angle, knee lifting is stopped (the knee lifting motor is turned off).

The back lifting angle of the back bottom section 3a is set for limiting the angle formed between the back bottom section 3a and the knee bottom section 3b, for example, at 90° or more.

Since the back lifting speed and the knee lifting speed are constant when the electric power to the motors is constant, the knee lifting angle a can also be preset as a predetermined time period T based on the relation.

The motors 8a and 8b respectively have, for example, adequate rotation quantity detecting means (not illustrated) for identifying the present state of the bottom sections, i.e., the position information in reference to the rotation quantities of the motors. The signals detected by the rotation quantity detecting means are sent as position information to the controller 7, and further to the control panel 6, and are displayed, for example, by a display means (LEDs, etc.) for letting the operator recognize as the position information of the bottom sections.

According to the bottom adjusting action control system 4 described above, when the back lifting of the back bottom section 3a is carried out, since a bottom coordinative action pattern accompanying the action of the knee bottom section 3b is used, the back lifting can be adjusted with the forward sliding and pressure feeling of the lying person kept small, hence with a less burden imposed on him/her.

In this case, the knee lifting angle a at which the pressure feeling is felt is different from person to person, and the body weight is also different from person to person. Since the loads acting on the motors 8a and 8b are different, the back lifting speed and the knee lifting speed also become different. So, if the time difference setting switch St for presetting the time difference (t) between the time instant of starting the back lifting of the back bottom section 3a and the time instant of starting the knee lifting of the knee bottom section, and the angle setting switch Sa for presetting the knee lifting angle a (time T) are operated for re-presetting the time difference (t) and the knee lifting angle a respectively, and the time difference and the knee lifting angle are stored in the storing means 9, then back lifting can be carried out effectively according to the bottom coordinative action pattern newly stored in the storing means 9.

For example, if the head lifting switch Sw1 on the control panel 6 is operated with the bottom 3 kept lying flat, to apply an action command for starting the back lifting, action power is at first supplied to the motor 8b functioning as a directly acting drive mechanism of the knee lifting mechanism, to displace the knee lifting link, for inclining the knee bottom section 3b. Then, after lapse of time t, the back lifting motor is turned on to supply action power to the motor 8a functioning as a directly acting drive mechanism of the back lifting mechanism, to displace the back lifting link, for inclining the back bottom section 3a. Then, if the knee lifting angle a of the knee lifting bottom section 3b reaches the preset angle, the knee lifting motor 8b is turned off, and is turned on for reverse rotation. At this moment, the electric power for starting the reverse rotation is given to the knee lifting motor 8b, to lower the knee bottom section 3b.

The bottom adjusting action control system 4 of this invention also allows a bottom coordinative action pattern to be preset also for the gatch action with forward body sliding and pressure feeling reduced. Also in this case, since the knee lifting angle a at which the pressure is felt is different from person to person, the angle setting switch Sa for adjusting the knee lifting angle a on the control panel 6 is preset at a desired knee lifting angle. Furthermore, the time difference (t) between the time instant of starting the action of the back bottom section and the time instant of starting the action of the knee bottom section is present by means of the time difference setting switch St.

The maximum back lifting angle of the back bottom section 3a is limited in relation with the knee lifting angle a of the knee bottom section 3b (for example, 90° or more).

If the back lifting knee lifting coordinative switch Sw5 on the control panel 6 is operated to apply an action command for carrying out the gatch action, at first action power is supplied to the motor 8b functioning as a directly acting drive mechanism of the knee lifting mechanism, to displace the knee lifting link, for inclining the knee bottom section 3b. Then, after lapse of time t, the back lifting motor is turned on to supply action power to the motor 8a functioning as a directly acting drive mechanism of the back lifting mechanism, to displace the back lifting link, for inclining the back bottom section 3a.

Then, after lapse of the predetermined time period (T) when the knee lifting angle a of the knee bottom section 3b reaches the preset angle, the knee lifting motor is turned off, to stop the knee bottom section 3b, for keeping it inclined at the angle (the dotted line of FIG. 3).

The back bottom section 3a can be inclined until the angle between the back bottom section 3a and the knee bottom section 3b does not become smaller than 90°.

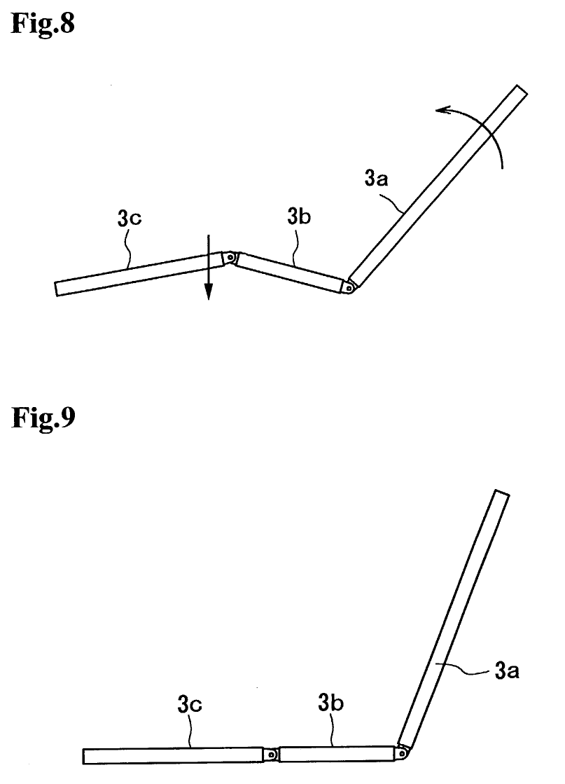

The preferred embodiments of the lifting and lowering pattern are described below in more detail in reference to FIGS. 4-9.

FIG. 4 shows a state where all the bottom sections 3a, 3b and 3c are kept down to lie flat, and in this state, a person such as a patient lies in an ordinary position. To let the lying person get up by lifting his/her back portion from this state, control switches are operated to issue commands to that effect to the means for controlling the lifting mechanisms.

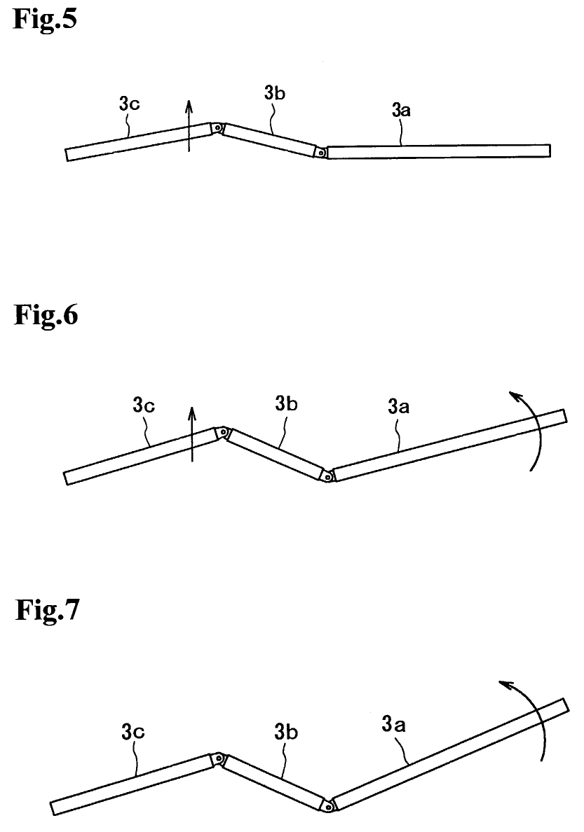

In this embodiment, the control means receiving a first one of the commands actuates at first the lifting mechanism of the knee bottom section 3b as shown in FIG. 5, to start lifting the knee bottom section 3b only. The time instant when the lifting of the knee bottom section 3b is started is t=0 in FIG. 3.

Then, receiving the subsequent one of said commands, the control means starts lifting the back bottom section 3a at the time instant (t=t) adequately later than the time instant when the lifting of the knee bottom section 3b is started, and thereafter as shown in FIG. 6, both the back bottom section 3a and the knee bottom section 3b are further lifted.

As described above, in this embodiment, for pivotally rotating and lifting the back bottom section 3a from a flat state where all the bottom sections are kept down to lie flat, at first the lifting of the knee bottom section 3b is started. Since the knee bottom section 3b is lifted, the knee bottom section 3b supports the position of the waist of the lying person, and therefore even if the lifting of the back bottom section is started in this state to gradually make the back bottom section steeply inclined, it can be prevented that the lying person is pressed at his/her back forward to slide forward.

If the lifting of the back bottom section 3a and the lifting of the knee bottom section 3b are continued further from the state of FIG. 3 without control, the angle formed between the back bottom section 3a and the knee bottom section 3b becomes gradually smaller to gradually bend the abdominal region of the lying person, finally letting him/her feel a pressure.

So, in this invention, the lifting of the knee bottom section 3b is not continued further without control, but if the knee bottom section 3b reaches a preset lifted position, it is not lifted any more.

FIG. 7 shows this state as a concept. If the knee bottom section 3b reaches the preset highest position, the lifting of the knee bottom section 3b is stopped thereafter, and the lifting of the back bottom section 3a only is continued. In this coordinative operation, if the maximum angle of the knee bottom section 3b to the maximum angle of the back bottom section 3a is preset, it does not happen that the angle formed between the back bottom section 3a and the knee bottom section 3b becomes smaller than a certain angle.

Therefore, it can be prevented that the abdominal region of the lying person is gradually bent to let him/her feel a pressure.

The knee bottom section 3 that reaches the preset highest position (time instant of t=T in FIG. 3), hence the largest angle, can be controlled to maintain its position, but if it is controlled to decline from the highest position, a characteristic control action can be obtained as described below.

The control action is that, as shown in FIG. 3, after the knee bottom section 3b reaches the preset highest position (time instant of t=T in FIG. 3), the control means controls to let the lifting of the back bottom section 3b continue, but controls to lower the knee bottom section 3b. This control action is shown in FIG. 5 as a concept.

In this control action, even if the knee bottom section 3b is lifted further to have a larger angle at a certain time instant before the back bottom section 3a reaches its highest position, while the back bottom section 3a is further lifted to form a sharp angle, the angle of the knee bottom section 3b becomes gradually smaller. So, it does not happen either, that the angel formed between the back bottom section 3a and the knee bottom section 3b becomes smaller than a certain angle.

Therefore, in this control action, the effect of the knee bottom section 3b having a larger angle more positively prevents that the lifting of the back bottom section 3a presses the lying person at his/her back to let him/her slide forward, and it can be prevented that the abdominal region of the lying person is gradually bent between the back bottom section 3a and the knee bottom section 3b to let him/her feel a pressure.

The position to be reached by the knee bottom section 3b lowered from its preset highest position can be adequately preset, depending on various conditions. In the example shown in FIG. 9 and by the solid line of FIG. 3, the knee bottom section 3b is lowered to be flat.

Next, as a first method of detecting the time instant when the lifting of the back bottom section 3a is started (t=t) later than the time instant when the lifting of the knee bottom section 3b is started (t=0), and/or the time instant when the knee bottom section 3b reaches its highest position (t=T), to ensure that the control means can carry out the above-mentioned control action, the time elapsed from the time instant when the lifting of the knee bottom section 3b is started can be referred to for detecting said time instant.

In the case where the capacities of the drive sources such as motors for actuating the lifting mechanisms of the back bottom section 3a and the knee bottom section 3b are sufficiently larger than the forces necessary for lifting the back bottom section 3a and the knee bottom section 3b on which the load of the lying person acts, or in the case where the load is constant, there is a constant correlation between the time elapsed after the time instant of actuating a lifting mechanism and the position of the corresponding lifted bottom section 3a or 1b. So, the elapsed time easy to control can be used to carry out the above-mentioned control action in response to the lifted position of the bottom section 3a or 1b.

In this case, if it is ensured that the preset values of said time instants T1 and T2 in the control means can be changed, an adequate control action suitable for various conditions such as the person lying on the bottom can be carried out.

As a second method of detecting the time instant when the lifting of the back bottom section 3a is started (t=t) later than the time instant when the lifting of the knee bottom section 3b is started (t=0), and/or the time instant when the knee bottom section 3b reaches its highest position (t=T), to ensure that the control means can carry out the above-mentioned control action, a position detecting means such as an angle sensor can be installed for the knee bottom section 3b, for detecting the position. The position detecting means for the knee bottom section 3b can be installed at an adequate place, for example, the knee bottom section per se, the lifting mechanism or the drive source such as a motor.

Also in this case, if arrangement is made to ensure that the respective positions can be preset, an adequate control action suitable for various conditions such as the person lying on the bottom can be carried out.

The control action of the back bottom section 3a and the knee bottom section 3b to which this invention is applied has been described as an action in the case where the back bottom section is pivotally rotated and lifted to be kept inclined from a flat state where all the bottom sections are kept down to lie flat. The action in the case where all the bottoms are lowered to be flat from a lifted state where the back bottom section is pivotally rotated and lifted to be most inclined, is reverse to the action explained for the case of lifting. So, the explanation for the latter case of lowering is not made.

But in another embodiment, the action in the case where all the bottoms are lowered to be flat from a lifted state where the back bottom section is pivotally rotated and lifted to be most inclined, maybe different from the reverse action to the action explained for the case of lifting.

Also in the action for lowering, since the knee bottom section lifted to a certain position or the highest position is lowered thereafter, a similar action occurs when the knee bottom section is lowered. So, it can be prevented that the person lying on the bottom slides forward, and when the entire bottom becomes flat, the person lying on the bottom is not displaced. So, the trouble that the caregiver must return the lying person to the original position can be saved.

### INDUSTRIAL APPLICABILITY

As described above, this invention can exhibit the following effects.

(1) When the bottom sections of a bed or the like are adjusted to desired positions, they can be adjusted according to a desired adjusting action pattern. So, the bottom sections can be adjusted to suit the lying person with a less burden imposed on him/her.

(2) When the lifting of the back bottom section and the lifting of the knee bottom section of a bed or the like are adjusted, the adjustment can be carried out according a bottom coordinative action pattern suitable for the lying person. So, the lifting and lowering of the bottom sections can be adjusted with a less burden imposed on the body of the lying person.

(3) The time difference between the time instant of starting the knee lifting of the knee bottom section and the time instant of starting the back lifting of the back bottom section, and the knee lifting angle of the knee bottom section (knee lifting time period), can be preset, to simply and newly preset a bottom coordinative action pattern.

1. A bottom adjusting action control system for a bed or the like, characterized in that when the bottom sections of the bed or the like are adjusted to desired positions, an adjusting action pattern till reaching the desired positions can be preset.

2. A bottom adjusting action control system for a bed or the like, characterized in that when a back bottom section is lifted and lowered, a bottom coordinative action pattern for back lifting and lowering accompanying knee lifting and lowering till reaching a back lifting angle of the back bottom section can be preset.

3. A bottom adjusting action control system for a bed or the like, characterized in that when the lifting of the back bottom section and the lifting of the knee bottom section of the bed or the like are adjusted, a bottom coordinative action pattern till reaching desired positions can be preset.

4. A bottom adjusting action control system for a bed or the like, according to claim 2, wherein the time difference between the time instant of starting the knee lifting of the knee bottom section and the time instant of starting the back lifting of the back bottom section, and a knee lifting time period of the knee bottom section, are preset in a bottom coordinative action pattern for the back lifting of the back bottom section, wherein the knee lifting of the knee bottom section is started at first; subsequently after lapse of said preset time difference, the back lifting of the back bottom section is started; and after lapse of said preset knee lifting time period of the knee bottom section, the knee lifting of the knee bottom section is stopped and then the knee lowering of the knee bottom section is started, while the back lifting of the back bottom section is continued till reaching a desired back lifting angle.

5. A bottom adjusting action control system for a bed or the like, according to claim 3, wherein the time difference between the time instant of starting the knee lifting of the knee bottom section and the time instant of starting the back lifting of the back bottom section, and a knee lifting angle of the knee bottom section, are preset in a bottom coordinative action pattern for adjusting the back lifting and knee lifting of the respective bottom sections, wherein the lifting of the knee bottom section is started at first; subsequently after lapse of said preset time difference, the back lifting of the back bottom section is started; and if the knee bottom section reaches the preset knee lifting angle, the knee lifting of the knee bottom section is stopped, while the back lifting of the back bottom section is continued till reaching a predetermined back lifting angle.
